(19) United States
(12) Patent Application Publication
(10) Pub. No.: US 2024/0046258 A1
(43) Pub. Date: Feb. 8, 2024

(54) GROUP PAYMENT ACCOUNTS

(71) Applicant: Wells Fargo Bank, N.A., San Francisco, CA (US)

(72) Inventor: Phillip H. Griffin, Raleigh, NC (US)

(21) Appl. No.: 16/719,117

(22) Filed: Dec. 18, 2019

(51) Int. Cl. G06Q 20/38; H04L 9/32

(52) U.S. Cl. CPC G06Q 20/3825; H04L 9/3247

(57) ABSTRACT

Systems and methods relating to leveraging group signature technology allowing a group manager to control an account with several members whether in a family or business environment. In some instances, this allows for control of a single account verifiable through a digital signature that is presented to the outside, but further allows for great granular control by the group manager on spending and functionality available to each individual member.

### BACKGROUND

Partially anonymous requests for purchase may be useful in a number of situations that benefit from the ability of a person to send a request for purchase using a group signature to another person or group while only revealing the group the purchaser is a member of. There are many different types of digital signature schemes and each type has its own characteristics, usage benefits, and drawbacks. Some of these schemes can be described as anonymous digital signature schemes and examples may include signatures associated with X.509 digital certificates and the SignedData type defined in the Cryptographic Message Syntax (CMS) standards widely used by businesses (X9.73), in the IETF to implement secure electronic mail, or X.894 that standardizes CMS for the telecommunications industry. Though anonymous digital signatures are known, there is now a renewed interest in their application to new and emerging technologies.

### SUMMARY

Systems and methods are described to leverage group signature technology to allow a group manager to control an account with several members whether in a family or business environment. In some instances, this allows for control of a single math-based-currency account that is presented to the outside, but further allows for great granular control by the group manager on spending and functionality available to each individual member.

Various implementations relate to a system including a group payment account system. The group payment account system may include a network interface circuit and an account circuit. The network interface circuit may be configured to receive, from a user computing system, data comprising a request to transfer currency, wherein at least a portion of the data is signed with a group signature. The account circuit may be configured to determine a group account membership of a sender of the request based on the group signature, determine a spending threshold or limit applies to the request based on a group account associated with the group account membership, apply one of the spending threshold or limit to the request to transfer currency, and transfer the currency to a recipient based on application of the spending threshold or limit.

In some implementations, the group payment account system further comprises an opening circuit. The opening circuit may be configured to open an identity of the sender of the request to transfer currency. The application of one of the spending threshold or limit may require using the opening circuit to open the identity of the sender of the request to transfer currency. In some implementations, the group payment account system comprises a linking circuit. The linking circuit may be configured to link the at least the portion of the data signed with the group signature to a second at least a portion of data signed with the group signature associated with a previous request. The application of one of the spending threshold or limit may require using the linking circuit to link the at least the portion of the data signed with the group signature to the second at least the portion of data signed with the group signature associated with the previous request.

In some implementations, the currency is a math-based currency (“MBC”) and the group signature is associated with an amount of the math-based currency. In some implementations, the data may further comprise a request to purchase and an identifier of one of a good or service. In some implementations, the data may further comprises a recipient address to send the currency. In some implementations, the account circuit is further configured to submit a currency transfer request to a node of a blockchain associated with the MBC.

Various other implementations relate to a method. The method may execute on a group payment account system. The method may include receiving, from a user computing system, data comprising a request to transfer currency, wherein at least a portion of the data is signed with a group signature. The method may further include determining, using an account circuit, a group account membership of a sender of the request based on the group signature, determining a spending threshold or limit applies to the request based on a group account associated with the group account membership, applying one of the spending threshold or limit to the request to transfer currency, and transferring the currency to a recipient based on application of the spending threshold or limit.

In some implementations, a method further comprises opening, using an opening circuit, an identity of the sender of the request to transfer currency. Applying the one of the spending threshold or limit may require opening the identity of the sender of the request to transfer currency. In some implementations, a method further comprises linking, using a linking circuit, the at least the portion of the data signed with the group signature to a second at least a portion of data signed with the group signature associated with a previous request. Applying the one of the spending threshold or limit may require using the linking circuit to link the at least the portion of the data signed with the group signature to the second at least the portion of data signed with the group signature associated with the previous request. In some implementations, the currency is a math-based currency and the group signature is associated with an amount of the math-based currency. In some implementations, the data further comprises a request to purchase and an identifier of one of a good or service. In some implementations, the data further comprises a recipient address to send the currency. In some implementations, the method further comprises submitting a currency transfer request to a node of a blockchain associated with the MBC

Other implementations relate to non-transitory computer-readable storage media storing instructions that are executable by one or more processors to perform operations including one or more of the above methods.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a schematic diagram of a group payment account environment, according to an example implementation.

FIG. 2 is a flow diagram of a method of managing an action associated with group membership according to an example implementation.

FIG. 3 is a flow diagram of a method of managing a request to transfer currency according to an example implementation.

FIG. 4 is a schematic diagram of a graphical user interface for submitting a request to transfer currency according to an example implementation.

### DETAILED DESCRIPTION

Systems and methods are described to leverage group signature technology to allow a group manager to control an account with several members whether in a family or business environment. In some instances, this allows for control of a single math-based-currency account that is presented to the outside, but further allows for great granular control by the group manager on spending and functionality available to each individual member. For example, one or more group members may have a set limit on the amount of spending in a given time period. In another example, a group member may only be allowed to conduct certain financial transactions or types of financial transactions. Group signatures allow for one group public key and a plurality of private keys, where each private key is associated with a group member. Signatures created by different group members are indistinguishable to verifiers but the group manager is able to determine which member has signed or to link member signatures and implement controls and limits. In some implementations, the controls and limits are done with the cooperation of a Digital Certificate Authority which issues digital certificates. Group signatures are anonymous digital signature mechanisms in which a relying party uses a single group public key to verify the digital signatures of all group members, while each group member has their own distinct, private signing key. In some implementations, identification of a signer as belonging to a particular group or having a particular status or position is accomplished by adding an appropriate identifier in the group public key certificate. In some implementations, identification of a signer as belonging to a particular group or having a particular status or position is accomplished by unlocking a group member by the group manager.

Digital certificates are used by business and organizations to authenticate the identities of devices, employees, business partners, and regulators. Cryptographic keys associated with digital certificates may be used to sign ordinary email, create electronic signatures that comply with ESIGN and Uniform Electronic Transactions Act (UETA) requirements, sign transactions or smart contracts in blockchain and distributed ledger technology (DLT) environments, or enable entity authentication.

Group signatures are anonymous digital signature mechanisms in which a relying party uses a single group public key to verify the digital signatures of all group members, while each group member has their own distinct, private signing key. The present disclosure may relate to an extension of a group certificate that allows group users to conduct anonymous transactions in public, with the ability to subsequently audit and confirm signer identity. Further discussion of the group certificate extension may be found in application Ser. No. 16/429,629 which is incorporated herein in its entirety by reference. Auditing and confirmatory functions of the group manager may include group signature openers that are configured to reveal the identity of a signer that is a member of a group by their signature. Auditing and confirmatory functions of the group manager may also include group signature linkers that are configured to link two signatures (i.e., signed data) to the same signer using a linking key or linking base In some implementations, regulators may contact the group manager through analysis of the group certificate extension for access to opening or linking functionality.

In some implementations, in a group payment account environment each member of the group has a public and private key pair. The group manager may create the security parameters related to the group and may issue the group public key and work with each member of the group in the creation of their respective private key. The creation of each respective private key may be an iterative process with where each private key is created to work with an already generated group public key. The end result is each group member ends up with each group's own assigned private key paired with the one public key.

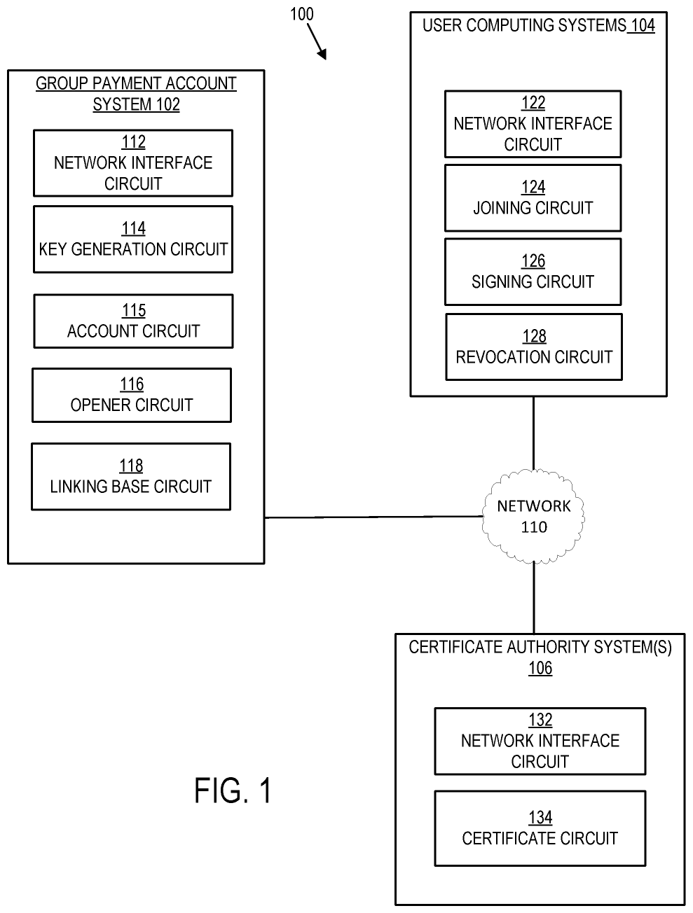

Referring to FIG. 1, a schematic diagram of a group payment account environment 100 is shown, according to an example implementation. The system 100 comprises a group payment account system 102, one or more user computing system(s) 104, one or more certificate authority system(s) 106, and a network 110. Each of the group payment account system 102, one or more user computing system(s) 104, and certificate authority system(s) is in operative communication with one or more of the others via the network 110. The network 110 may include, for example, the Internet, cellular networks, proprietary banking networks, and the like.

Generally, the group payment account system 102 is used to manage membership, privacy, key generation of a plurality of digitally signed data, and receipt of requests to purchase. Although various implementations may be described in connection with example systems and methods, it should be understood that the systems and methods described herein may similarly be used to provide a group payment account system in undescribed types of systems and methods, such as enterprise security and other types of systems. In some implementations, the group payment account system 102 may also be configured to communicate with or function as a Certificate Authority (i.e., will also be configured to function as certificate authority system 106) to obtain and/or validate digital certificates or to issue and validate digital certificates. While the group payment account system 102, one or more user computing system(s) 104, and one or more certificate authority system(s) 106 are shown as separate entities in FIG. 1, in some implementations a respective system may perform some or all of the functions of one of the other systems. For example, in some implementations, the group payment account system 102 may perform some or all of the functions of the certificate authority system 106. In another example, the certificate authority system 106 may perform one or more of the functions of the group payment account system 102. In some implementations, the user computing system 104 performs some of or all of the functions of the group payment account system 102 (e.g., the functions of the key generation circuit 114).

The group payment account system 102 includes a network interface circuit 112, a key generation circuit 114, an account circuit 115, an opener circuit 116, and a linking base circuit 118. Generally, the group payment account system 102 is structured to generate or facilitate generating group keys for signing data. The group payment account system 102 may, for example, include one or more servers each with one or more processors configured to execute instructions stored in a memory, send and receive data stored in the memory, and perform other operations to implement use of group payment account functions and related functions as described herein. The network interface circuit 112 is structured to facilitate operative communication between the group payment account system 102 and other systems and devices over the network 110.

The group payment account system 102 may comprise a key generation circuit 114. In some implementations, the key generation circuit 114 is configured to generate a public and private key pair, wherein the public key is the group public key. The key generation circuit 114 may also be configured to enroll members in the group. Enrolling members may including deriving and/or helping to derive their respective private key. In some implementations, the creation of each respective private key may be an iterative process where each private key is created to work with the already generated group public key. The end result is each group member ends up with their own assigned private key paired with the one group public key. Each respective private key is derived to work with established security parameters set by the group manager and the issued public group certificate.

The group payment account system 102 may comprise an account circuit 115. In some implementations, the account circuit 115 is configured to receive and generate communication to, including requests to purchase, (e.g., by using network interface 112) to a member of a group (e.g., to a user computing system 104). In some implementations, account circuit 115 is configured to determine when a request to purchase is received and a further determination made whether the request to purchase is properly formatted and signed. The request to purchase may be signed with a private group signature and accompanied by a digital certificate indicating membership in a group. The request to purchase may be signed with a private key and sent with a public key allowing for verification that the signer belongs to a group. The request to purchase may also be accompanied by information regarding which group the sender belongs to. In some implementations, account circuit 115 is further configured to verify that the signature associated with the request for purchase matches the information regarding which group the sender belongs to. In some implementations, account circuit 115 is configured to verify a digital certificate associated with the signature.

In some implementations, the account circuit 115 is configured to determine whether there are any thresholds and/or limits that apply to a request to purchase. In some implementations, for example, there may be an overall amount of spending that may be done by the group as a whole. There may also be predetermined threshold levels or limits of spending that may be done by each individual member of a group. These thresholds and/or limits may be cumulative or for a set time period. For example, a group may have a limit of a set amount that may be spent overall as well as a limit of a set amount that may be spent in a given twenty-four hour period. Further, each individual member of the group may also have a respective set amount that may be spent overall as well as a limit of a set amount for a given time period. The account circuit 115 may be configured to apply other rules and parameters. For example, one or more respective members of a group may be limited to specific organizations and/or businesses that they are allowed to send payment to using the group key. Conversely, one or more respective members of a group may be restricted from sending payment to specific organizations and/or businesses. Individual members may further be restricted to or from specific categories or types of organizations and/or businesses. Other permissions and/or restrictions may be applied to the members of the group as a whole or individual respective members or any combination of permissions and/or restrictions. A determination whether there are any thresholds, limits, rules, and/or parameters that may apply to the request to purchase may require one of opening and/or linking an identity of the purchaser. In some implementations, the thresholds, limitations, rules and/or parameters to be applied, if any, are determined by parameters associated with the group or the type of group associated with the group signature used to sign the request for purchase. In some implementations, application of the rules or parameters may require opening the identity of the signer of the request for purchase. In some implementations, application of the rules or parameters may require linking the signed request for purchase with other received signed request for purchase. For example, the group manager as part of or using the group payment account system 102 may be a trusted entity with the capability of opening (e.g., by using opener circuit 116) and/or linking (e.g., using linking base circuit 118) the signed request for purchase in order to apply any relevant thresholds, limits, rules or parameters. Application of the rules or parameters may not require opening the identity of the sender of the request for purchase, but instead require linking the received request for purchase to other received request for purchase to determine whether the parameter has been met. In another example, the content of the request for purchase may be analyzed and the application of a rule or parameter is dependent on the content of the request for purchase. Certain formatting may be required for certain types of request for purchase and the request for purchase is not passed on if the formatting is incorrect. The certain formatting may be dependent on which group the signer is a member with different formatting requirements for different groups. Other implementations and combinations for applying thresholds, limits, rules and/or parameters are possible depending on which group the signer is a member of, information contained in the request for purchase, a requirement to open and/or link signer identity, and/or other factors associated with receiving the signed request for purchase signed with a group signature.

In some implementations, the account circuit 115 is configured to analyze if a determination is made that application of the thresholds, limits, rules and/or parameters requires opening the received, signed request for purchase. In some implementations, the group manager must be a trusted party in order to be given the capability of opening the received, signed request for purchase. In some implementations, the group manager must be a trusted 3r d party in order to be given the capability of opening the received, signed request for purchase and separate from any business or other organization using the group payment account environment (e.g., group payment account environment 100). In some implementations other conditions must first be met in order to open the received, signed request for purchase. Conditions may include, the request for purchase has been received by the appropriate group payment system (e.g., group payment account system 102), the request for purchase has been correctly signed using a group signature, and/or the request for purchase meets any required formatting requirements.

In some implementations, the account circuit 115 is configured to open an identity of a signer of request for purchase (e.g., by using opener circuit 116). In some implementations, a group manager of the group payment account environment (e.g., using group payment account environment 100) has the ability to open a signature signed by a group member by identifying the member of the group that signed the request for purchase. While signatures that are created by different group members are indistinguishable to a verifier of the digital signature, they are not indistinguishable to the group manager (e.g., a group manager using group payment account system 102 and the opener circuit 116) who may be able to disclose the identity of any member of the group. In some implementations, opener circuit 116 is configured to use a secret master key associated with the group that can be used to extract the identity of the signing group member. This capability provides the property of signer traceability, in what is are sometimes referred to as ‘traceable signatures.’ No one that is without possession of the secret master key (e.g., a secret master key held by a group manager) should be able to determine which group member was the signer. This capability provides the property of signer anonymity. In some implementations, the individual signatures of the group members may be a type of traceable signature, where the signature of a single member of the group may be traced without opening signatures or revealing identities of any other member of the group. In some implementations, a group manager of the group payment account environment (e.g., group payment account environment 100) has the ability to link a signature signed by a group member to other received, signed request for purchase. While signatures that are created by different group members are indistinguishable to a verifier of the digital signature, a linking base circuit (e.g., linking base circuit 118) may be configure to link different signatures together to identify a plurality of request for purchase that is linked to the same member of a group without revealing the identity of the group member.

In some implementations, the membership circuit is configured to accept the request for purchase given appropriate conditions and parameters have been met. In some implementations, the account circuit 115 is configured to transmit the request for purchase to the proper recipient upon acceptance of the request for purchase. The request for purchase may be accompanied by the group the sender of the request for purchase is a member of.

The group payment account system 102 may comprise an opener circuit 116. In some implementations, the opener circuit 116 is configured to open a signature signed using a group signature by identifying the member of the group that signed the data. While signatures that are created by different group members are indistinguishable to a verifier of the digital signature, they are not indistinguishable to a computer system controlled by a group manager who can disclose the identity of any member of the group. In some implementations, the group payment account system 102 is configured with a secret master key that can be used to extract the identity of the signing group member. This capability provides the property of signer traceability, in what is are sometimes referred to as ‘traceable signatures.’ No computing system that is not configured to use the secret master key (e.g., a group payment account system 102 configured with a secret master key) should be able to determine which group member was the signer. This computing system capability provides the property of signer anonymity. In some implementations, the individual signatures of the group members may be a type of traceable signature, where the signature of a single member of the group may be traced without opening signatures or revealing identifies of any other member of the group.

The group payment account system 102 may comprise a linking base circuit 118. In some implementations, the linking base circuit 118 is configured to link two or more received signatures as being signed by the same group member without revealing the identity of the group member. The two or more signatures may be linked using a linking key or linking base. The linking base circuit 118 may further be configured to execute a linking process that is able to take two valid, linkable signatures signed using a group signature scheme and determine if they are linked. In other words, that they have been signed by the same member of the group. In some implementations, linking outputs a value of ‘1’ if the signatures are linked and a value of ‘0’ if the signatures are not linked.

The user computing system 104 may include a network interface circuit 122, a joining circuit 124, a signing circuit 126, and a revocation circuit 128. Generally, the user computing system 104 structured to help create private keys for joining a group and sign data. The user computing system 104 may, for example, include one or more processors configured to execute instructions stored in a memory, send and receive data stored in the memory, and perform other operations as part of a group payment account environment 100. The network interface circuit 122 is structured to facilitate operative communication between the user computing system 104 and other systems and devices over the network 110.

The user computing system 104 may comprise a joining circuit 124. In some implementations, the joining circuit 124 is configured to join a new member using the user computing system 104 to a group by deriving a respective private key for the new group member that is associated with the extant public group key. Further, the joining circuit 124 may be configured to join the group members by deriving a respective private key. The joining circuit 124 may be configured to execute a joining portion of an iterative process where the respective private key for the newly joining group member is created by sending a random number by the joining circuit 124 to a system that determines whether the private key thus created will work with the already generated group public key. The joining circuit 124 may thus be configured such that it receives a respective, assigned private key paired with the one group public key. The joining circuit 124 may be configured to derive each respective private key to work with the established security parameters associated with the group and the issued public group certificate.

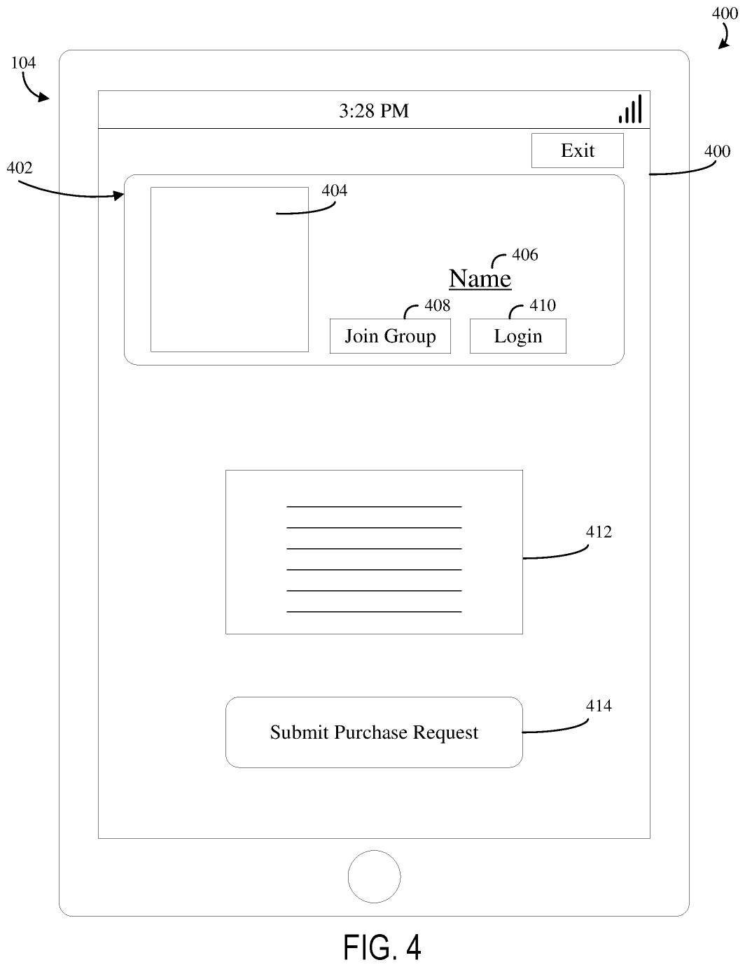

The user computing system 104 may comprise a signing circuit 126. In some implementations, the signing circuit 126 is configured to digitally sign data using the private key of a group member associated with the respective user computing system 104. The signing circuit 126 may also be configured to send a request for a digital certificate associated with the private key of the group member. In some implementations, a user may access signing circuit 126 through a graphical user interface on the user computing system 104 (e.g., a graphical user interface as illustrated in FIG. 4).

The member computing system 104 may comprise a revocation circuit 128. In some implementations, the revocation circuit 128 is configured to revoke the ability of the user to sign using their private key associated with the group public key. In some implementations, a user may access the revocation circuit 128 through a graphical user interface on the member computing system 104 (e.g., a graphical user interface as illustrated in FIG. 4). In some implementations, a user (e.g., using a graphical user interface 400) may ask to be revoked. In some implementations, an administrator may instead ask for a user to be revoked. The user may be fully revoked such that all signed data by the user is no longer verifiable or partially revoked such that data signed by the user going forward is no longer verifiable.

The certificate authority system 106 includes a network interface circuit 132 and a certificate circuit 134. The certificate authority system 106 may, for example, include one or more servers each with one or more processors configured to execute instructions stored in a memory, send and receive data stored in the memory, and perform other operations to implement the services described herein associated with the processing modules, databases, and processes. In some implementations, the certificate authority system 106 is configured to issue digital certificates. In one example, a digital certificate may certify the ownership of a public key by the named subject of the certificate. In some implementations, the format of these certificates may be specified by the X.509 standard. The network interface circuit 132 is configured to facilitate operative communication between the certificate authority system 106 and other systems and devices over the network 110. underlying signing mechanisms are based on cryptographic techniques that can be automated.

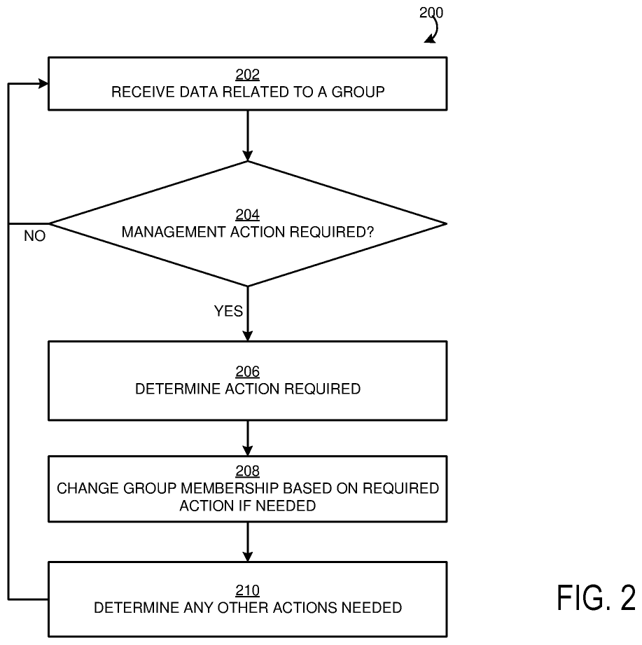

Referring to FIG. 2, a flow diagram of a method 200 of managing an action associated with group membership is shown according to an example implementation. In some implementations, the method 200 is executed using a group payment account system 102 (e.g., a key generation circuit 114 and/or account circuit 115 of a group payment account system 102). In brief, method 200 comprises receiving data related to a group and determining if management action is required. If management action is required, the action required is determined, a group member may be added as part of the required action, and a determination is made if any other actions are needed.

Still referring to FIG. 2 and in more detail, at 202, data related to a group is received. In some implementations, the data may be associated with one or more member of the group. The data may be associated with a request to remove a member or add a member to the group. The data may be a request to add an individual to a group associated with a previously generated group public key. The data may also be accompanied by additional data providing support for evidence that the individual should be considered to be a member of the group they are being added to. The data may instead be a request to revoke group membership of one or more members of the group or to revoke membership of all members of the group and/or dissolve the group. In some implementations, the data related to the group may be information related to a member of a group no longer being employed with a business, government, or other entity associated with the group. In some implementations, the data related to the group may be information related to improper, malicious, or unlawful activity related to one or more group members that may prompt further action by the group manager.

At 204, a determination is made if management action is required and what action is required at 206. In some implementations, a management action may be the addition of an individual to a group membership to be associated with a previously generated group key. In some implementations, a management action may be the revocation of group membership from a member of a group or a revocation of an available capability from a member of the group. The action required may be a creation or update of a blacklist or revocation list. In some implementations, the action required may be to revoke the entire group, revoke a single group member, or modify or remove specific signing capabilities of one or more members of the group. Where the action is being done by the Certificate Authority, the management action may be incorporated directly into a Digital Certificate validation or verification functionality of the Certificate Authority. Where the action is being done by a management system that is not the Certificate Authority (e.g., a group payment account system 102), the action may comprise sending instructions or an update to a Certificate Authority. The instructions or update may be signed or comprise other verification of the authority of the sender to make the requested changes.

At 208, a group membership may be changed based on the required action if needed. In some implementations, one or more group members may be added based on the determination of what action is required. In some implementations, the addition of an individual to a group membership to be associated with a previously generated group key. In some implementations, revocation of membership is done by a verifier blacklist. For example, in a verifier blacklist implementation, a verifier (i.e., a Certificate Authority) may generate a blacklist where the linking tag of any revoked members is checked against future signatures. In some implementations, if the check fails a value of ‘0’ is outputted (i.e., revoked) and validates if a value of ‘1’ is outputted. In some implementations, the blacklist or an update to the blacklist is transmitted to one or more Certificate Authorities that generate and/or verify digital certificates with the group certificate extension. In some implementations, the group manager may function as the Certificate Authority. Up to three levels of revocation may be performed, for example, the entire group may be revoked, a single group member may be revoked, or specific signing capabilities of one member may be revoked. In some implementations, a user (e.g., using a graphical user interface 400) may ask to be revoked. In some implementations, an administrator may instead ask for a user to be revoked.

At 210, a determination is made if any other actions are needed. In some implementations, addition of a group member or a revocation action may lead to other actions that need to be executed. Other actions may include, transmitting a notification to the group member that the group member has been added to the group or that a revocation of group membership has occurred. In some implementations, the initiation of generating a private key associated with the relevant group public key may commence as described above. In the event of a revocation of group membership, the notification may include details on why there is a revocation and/or what the group member would have to do to rejoin the group and/or regain functionality that was removed.

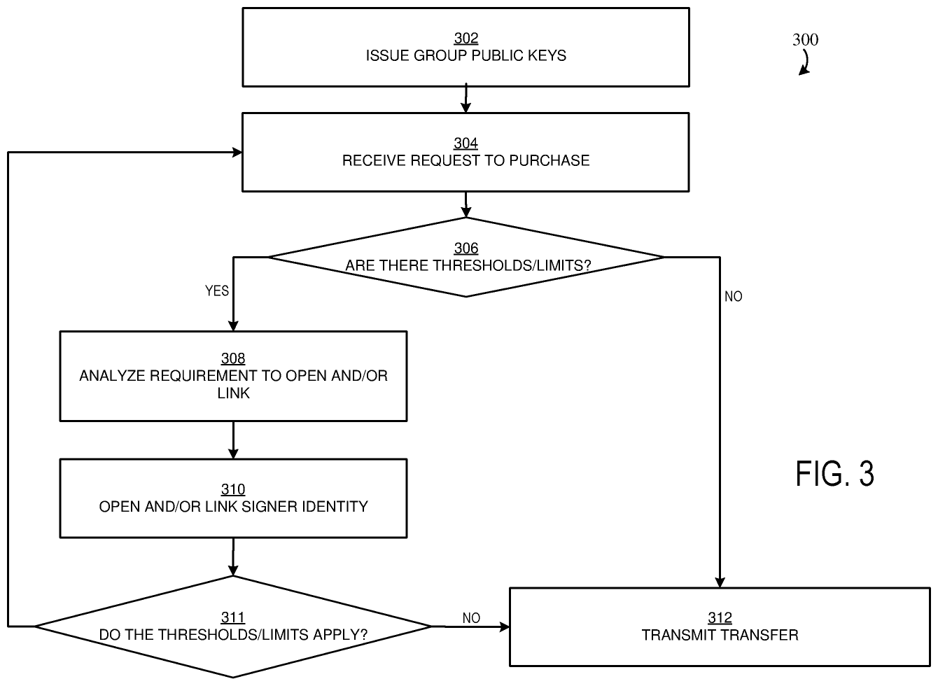

Referring to FIG. 3, a flow diagram of a method 300 of managing a request to transfer currency is shown according to an example implementation. In some implementations, method 300 is executed using a group payment account system 102 (e.g., a key generation circuit 114, an account circuit 115, an opener circuit 116, and/or a linking base circuit 118). In brief, method 300 comprises issuing group public keys and receiving a request to make a purchase. If a request to purchase is received, a determination is made whether there are thresholds and/or limits that apply to the request. If there are thresholds and/or limits that apply, there may be a requirement to open and/or link a signer identity associated with a digital signature used to sign at least a portion of the data associated with the request. If opening and/or linking of a signer identity associated with the request is required, the signer identity is opened and/or linked and a determination is made if the thresholds and/or limits apply to the request. If the thresholds and/or limits do not apply to the request to purchase, than a transfer of currency is transmitted.

The method 300 begins at 302 with issuing group public keys. In some implementations, a group manager is responsible for generating public and private keys for various groups within an organization. For example, a group has a plurality of members and is managed by the group manager, with the adding of group members managed by the group manager. In some implementations, an associated group public key certificate is requested from a Certificate Authority by a group manager. For example, a group has a plurality of members and a single manager, all associated with a single signature verification key. A trusted authority (e.g., a Certificate Authority) establishes the group with a public digital certificate associated with the group public key with each group member having their own signing private key with which digital signatures that can be verified using the group public key. The group manager may be able to open a signature associated with any group signature by showing which group member signed the associated signature or linking two signatures by associating it with the same group member without necessarily revealing the identity of the same group member. In some implementations, a group manager when creating the group sets some security parameters (e.g., ISO, IC2008 standard group signature parameters). Once security parameters are set the group may be set up through the issuance of a public key for the group and a public digital certificate associated with the public key through a request to a Certificate Authority or self-issuance. Each member of the group may be enrolled by deriving their respective private key. The creation of each respective private key may be an iterative process with where each private key is created to work with the already generated group public key. The end result is each group member ends up with their own assigned private key paired with the one public key. Each respective private key is derived to work with the established security parameters and the issued public group certificate. The issued public group certificate may be issued with an extension (e.g., a group signature extension). The group certificate extension may be analyzed to identify a value associated with the extension identifying the group manager. The group certificate extension may be designated as non-critical. For example, a certificate authority may validate a digital certificate without checking for the extension and/or any data values associated with the extension. In some implementations, the group manager is identified by a uniform resource identifier (URI) that allows for a determination of who is operating the group allowing for a request to be sent to open a signature associated with one of the group signatures or link two or more signatures potentially associated with one of the group signatures. In some implementations, the certificate extension allows for a regulator with appropriate authority to contact the group manager for opening or linking functionality. The certificate extension is discussed in more detail in application Ser. No. 16/429,629 which is incorporated herein in its entirety by reference. In some implementations where the group manager and the Certificate Authority are the same entity, the group manager may perform a revocation of membership for a member of the group, wherein the Certificate Authority is able to check the signature against a revocation list. In some implementations, the group manager may provide the information necessary to the Certificate Authority to check the signature against a revocation list or blacklist. A secure channel may have to be initiated between the group manager and each group member to maintain a secure, managed group.

In one implementation, creating a functional linkable group signature comprises (1) key generation, (2) signing, (3) verification, (4) linking, and (5) revocation. The first part (1) of a group manager creating a group signature may comprise key generation. The group manager creates the group public parameters. The group manager executes an issuing process which is executed between the group manager and each group member to create a unique signature key with a private key and a group membership certificate for each group member. In some implementations, the group manager chooses the group public parameters and random generators. Adding a member is an iterative process where the group manager does not know the final result, private key created for the member but the group manager chooses a random prime number and computes a value that the member can check against. The second part (2) of a group manager creating a group signature may comprise the ability of a group member to sign by taking as an input the group member signature key, a linking base, and the data to be signed and outputting a linkable signature. The third part (3) may comprise verification comprising taking a message, a linkable signature, and the group private key corresponding to the group. In some implementations, a value of ‘1’ is returned if the signature is valid and a value of ‘0’ if the signature is not valid. The fourth part (4) may comprise a linking process that is able to take two valid, linkable signatures and determine if they are linked. In other words, that they have been signed by the same member of the group. In some implementations, linking outputs a value of ‘1’ if the signatures are linked and a value of ‘0’ if the signatures are not linked. The fifth part (5) may comprise a revocation part. In some implementations a private key revocation is implemented. In some implementations, a verifier blacklist is implemented. For example, in a verifier blacklist implementation, a verifier (i.e., a Certificate Authority) may generate a blacklist where the linking tag of any revoked members is checked against future signatures. In some implementations, if the check fails a value of ‘0’ is outputted (i.e., revoked) and validates if a value of ‘1’ is outputted.

At 304, a request to purchase is received. In some implementations, data is received which includes a transfer of currency to a recipient. The currency may be fiat currency. The currency may be a cryptocurrency or a math based currency. The data received may be a MBC and further include a digitally signed transaction to a recipient address for entry to a blockchain where the transaction is digitally signed with a group signature. In some implementations, the transaction is signed with a private key (e.g., the private group key) creating a private signature and sent with a public key allowing for verification that the signer belongs to a group. data may also include information regarding which group the sender belongs to. In some implementations, receiving the data may include verifying that the signature associated with the request to purchase matches the information regarding which group the sender belongs to. In some implementations, receiving the data may include verifying a digital certificate associated with the signature. For example, the signature associated with the data may be verified to belong to a group associated with an MBC account.

At 306, a determination is made whether there are any thresholds and/or limits that apply to the request to purchase. In some implementations, for example, there may be an overall amount of spending that may be done by the group as a whole. There may also be predetermined threshold levels or limits of spending that may be done by each individual member of a group. These thresholds and/or limits may be cumulative or for a set time period. For example, a group may have a limit of a set amount that may be spent overall as well as a limit of a set amount that may be spent in a given twenty-four hour period. Further, each individual member of the group may also have a respective set amount that may be spent overall as well as a limit of a set amount for a given time period. Besides thresholds and limits, other rules and parameters might also be applied by a group manager. For example, one or more respective members of a group may be limited to specific organizations and/or businesses that they are allowed to send payment to using the group key. Conversely, one or more respective members of a group may be restricted from sending payment to specific organizations and/or businesses. Individual members may further be restricted to or from specific categories or types of organizations and/or businesses. Other permissions and/or restrictions may be applied to the members of the group as a whole or individual respective members or any combination of permissions and/or restrictions. A determination whether there are any thresholds, limits, rules, and/or parameters that may apply to the request to purchase may require one of opening and/or linking an identity of the purchaser.

At 308, the request to purchase is analyzed if a determination is that application of the rules and/or parameters requires opening and/or linking the received, request to purchase. In some implementations, application of the thresholds, limits, rules and/or parameters discussed may require opening the identity of the signer of the request to purchase. In some implementations, application of the rules or parameters may require linking the request to purchase with another received signed request to purchase. For example, the group manager may be a trusted entity with the capability of opening and/or linking the request to purchase in order to apply any relevant thresholds, limits, rules and/or parameters. Application of the rules or parameters may not require opening the identity of the sender of the request to purchase, but instead require linking the received request to purchase to other received requests to purchase to determine whether any limits or thresholds have been met. For example, there may be a spending limit that applies to all members of the group during a set time period. In order to apply this spending limit, it is not necessary to open the identity of purchaser but instead the request to purchase can be linked to other completed requests to purchase to see if the new request to purchase will exceed the spending limit. The new request to purchase can be rejected on this basis without revealing the identity of the individual making the request. In another example, data accompanying the request to purchase may be analyzed and the application of limit, threshold, rule or parameter is dependent on the content of the data accompanying the request to purchase. For example, the accompanying may include a business name or category from which the individual is purchasing goods or services. Certain formatting may be required for certain types of request to purchase and the request to purchase is not passed on if the formatting is incorrect. The certain formatting may be dependent on which rules and parameter associated with the group the signer is a member with different formatting requirements for different groups. Other implementations and combinations for applying limits, thresholds, rules and parameters are possible depending on which group the signer is a member of, information contained in the request to purchase, a requirement to open and/or link signer identity, and/or other factors associated with receiving the request to purchase signed with a group signature. In some implementations, application of the rules and/or parameters stems from a received request to open an identity of the signer. In some implementations, application of the rules and/or parameters stems from a received request to link an identity of the signer. Requests may, in some circumstances come from regulators with appropriate authority to contact a group manager for opening or linking functionality. In some implementations, this breaks the anonymity or partial anonymity (i.e., where one knows that someone in a group signed data but not the particular person) of the transaction in appropriate circumstances. In some implementations, using linking functionality, partial anonymity is still preserved as the only information provided is that two or more signatures are linked without revealing the particular signer in the group.

At 310, the identity of a signer of the request to purchase is opened and/or linked. In some implementations, a group manager of the anonymous request to purchase environment (e.g., group payment account environment 100) has the ability to open a signature signed by a group member by identifying the member of the group that signed the request to purchase. While signatures that are created by different group members are indistinguishable to a verifier of the digital signature, they are not indistinguishable to the group manager (e.g., a group manager using group payment account system 102 and the opener circuit 116) who can disclose the identity of any member of the group. In some implementations, the group manager has a secret master key that can be used to extract the identity of the signing group member. This capability provides the property of signer traceability, in what is are sometimes referred to as ‘traceable signatures.’ No one that is without possession of the secret master key (e.g., a secret master key held by a group manager) should be able to determine which group member was the signer. This capability provides the property of signer anonymity, where the larger the size of the group, the more anonymity for each group member is provided. In some implementations, the individual signatures of the group members may be a type of traceable signature, where the signature of a single member of the group may be traced without opening signatures or revealing identities of any other member of the group. In some implementations, a group manager of the anonymous request to purchase environment (e.g., group payment account environment 100) has the ability to link a signature signed by a group member to other received, signed request to purchase. While signatures that are created by different group members are indistinguishable to a verifier of the digital signature, they may be linked together by the group manager (e.g., a group manager using group payment account system 102 and the linking base circuit 118) who can identify a plurality of request to purchase that is linked to the same member of a group without revealing the identity of the group member.

At 311, a determination is made whether any thresholds and/or limits apply once the signer identity has been opened and/or linked. In some implementations, application of the thresholds, limits, as well as any rules and/or parameters may require opening the identity of the signer of the request to purchase. In some implementations, application of the rules or parameters may require linking the signed request to purchase with other received signed requests to purchase. For example, the group manager may be a trusted entity with the capability of opening and/or linking the signed request to purchase in order to apply any relevant rules or parameters.

At 312, the currency transfer is transmitted. In some implementations, fiat currency may be transferred from an account associated with the group to an account associated with the recipient. In some implementations where an MBC used, transaction information may be transmitted to MBC nodes which use the transaction information to verify MBC transactions. The MBC nodes may verify the transaction by verifying information relating to the transaction, such as determining that the signatures appear to be valid based on the group public key and the hash used in the transaction. The verification information may be published in a chain of transactions (i.e., a blockchain) that is later used for further verifications. Other entities may determine the verification status of the individual transactions by accessing the chain of transactions from the MBC nodes. The request to purchase may be accompanied by the group the sender of the request to purchase is a member of.

Referring now to FIG. 4, an interface 400 on a display of a user computing device (e.g., user computing device 104), including a graphical user interface for submitting a request to purchase, is shown according to an example implementation. In some implementations, the interface 400 and/or any generated information and/or generated private or public key values or associated values affecting an appearance of the interface 400 is provided by a group payment account system (e.g., an account circuit 115 of a group payment account system 102). The interface 400 may include information relating to various applications related to sending a request to purchase or related to joining a group associated with sending requests to purchase. An identifying profile may be provided by the group payment account system 102. A profile area 402 of the interface 400 may include information relating to the individual user, including a profile picture 404 and a user name 406. The profile picture 404 and user name 406 may be selected by the user. A user may be able to join and/or access a list of groups they are a member of by interacting with buttons 408 and 410 respectively. Various information related to group membership and current status may be displayed from within interface 400. In some implementations, a text area 412 may allow for entry of text associated with a request to purchase to be sent. In some implementations one or more display areas may be present on the interface 400, on pop-up screens, or additional screens of interface 400 (not shown) and used to display any applicable information associated with logging in to a particular group membership, joining a group, generating an associated private key while joining a group, sending a request to purchase, receiving confirmation of a successful purchase, and the like. Other implementations of interface 400 for joining a group associated with a group signature, generating and sending a request for purchase and receiving confirmation may contain similar features.

The implementations described herein have been described with reference to drawings. The drawings illustrate certain details of specific implementations that implement the systems, methods, and programs described herein. However, describing the implementations with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some implementations, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some implementations, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some implementations, the one or more processors may be embodied in various ways. The one or more processors may be constructed in a manner sufficient to perform at least the operations described herein. In some implementations, the one or more processors may be shared by multiple circuits (e.g., circuit A and circuit B may comprise or otherwise share the same processor which, in some example implementations, may execute instructions stored, or otherwise accessed, via different areas of memory). Alternatively or additionally, the one or more processors may be structured to perform or otherwise execute certain operations independent of one or more co-processors. In other example implementations, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some implementations, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit,” as described herein, may include components that are distributed across one or more locations.

An exemplary system for implementing the overall system or portions of the implementations might include a general purpose computing computers in the form of a computer, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some implementations, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other implementations, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example implementations described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative implementations. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps, and decision steps.

The foregoing description of implementations has been presented for purposes of illustration and description. It is not intended to be exhaustive or to limit the disclosure to the precise form disclosed, and modifications and variations are possible in light of the above teachings or may be acquired from this disclosure. The implementations were chosen and described in order to explain the principals of the disclosure and its practical application to enable one skilled in the art to utilize the various implementations and with various modifications as are suited to the particular use contemplated. Other substitutions, modifications, changes, and omissions may be made in the design, operating conditions and arrangement of the implementations without departing from the scope of the present disclosure as expressed in the appended claims.

1. A group payment account system comprising:
a network interface circuit to:
in response to a selection of one or more interactive buttons of a graphical user interface (GUI), receive, from a user computing system, data comprising an anonymous request for transferring an amount of currency, wherein at least a portion of the data is signed with a group signature and a linking base, wherein the amount of currency is a math-based currency (MBC) and the group signature designates an amount of the MBC;
an opening circuit to open an identity of the sender of the request; and
an account circuit to:
present, via the user computing system, the GUI comprising a profile area and the one or more interactive buttons;
link the at least the portion of the data signed with the group signature to a second at least a portion of data signed with the group signature of a previous request;
in response to validating the linking base, determine a group account membership of the sender of the request based on the group signature;
determine a spending threshold or limit applies to the request based on a group account of with the group account membership and the identity of the sender of the request;
apply one of the spending threshold or limit to the request for transferring an amount of currency;
transfer the amount of currency to a recipient based on application of the spending threshold or limit; and
submit the transfer of the amount of currency request and a group public key of the group account to a MBC node of a blockchain storing the math-based currency.

2. (canceled)

3. The group payment account system of claim 2, wherein
application of one of the spending threshold or limit requires using the opening circuit and opening the identity of the sender of the request for transferring an amount of currency.

4. The group payment account system of claim 1, further comprising a linking circuit to link the at least the portion of the data signed with the group signature to the second at least the portion of data signed with the group signature a of the previous request.

5. The group payment account system of claim 4, wherein application of one of the spending threshold or limit requires using the linking circuit and linking the at least the portion of the data signed with the group signature to the second at least the portion of data signed with the group signature of the previous request.

6. (canceled)

7. The group payment account system of claim 1, wherein the data further comprises a purchase request and an identifier of one of a good or service.

8. The group payment account system of claim 1, wherein the data further comprises a recipient address.

9. (canceled)

10. A method, executing on a group payment account system, the method comprising:
presenting, via a user computing system, a graphical user interface (GUI) comprising a profile area and one or more interactive buttons;
in response to a selection of the one or more interactive buttons, receiving, from the user computing system, data comprising an anonymous request for transferring an amount of currency, wherein at least a portion of the data is signed with a group signature and a linking base, wherein the amount of currency is a math-based currency (MBC) and the group signature designates an amount of the MBC;
linking the at least the portion of the data signed with the group signature to a second at least a portion of data signed with the group signature of a previous request;
in response to validating the linking base, determining, by an account circuit, a group account membership of a sender of the request based on the group signature;
opening, by an opening circuit, an identity of the sender of the request;
determining a spending threshold or limit applies to the request based on a group account of the group account membership and the identity of the sender of the request;
applying one of the spending threshold or limit to the request for transferring an amount of currency;
transferring the amount of currency to a recipient based on application of the spending threshold or limit; and
submitting the transfer of the amount of currency request and a group public key of the group account to a MBC node of a blockchain storing the math-based currency.

11. (canceled)

12. The method of claim 2, wherein applying the one of the spending threshold or limit requires opening the identity of the sender of the request for transferring an amount of currency.

13. The method of claim 10, wherein linking is executed by a linking circuit.

14. The method of claim 13, wherein applying one of the spending threshold or limit requires using the linking circuit to link the at least the portion of the data signed with the group signature to the second at least the portion of data signed with the group signature of the previous request.

15. (canceled)

16. The method of claim 10, wherein the data further comprises a purchase request and an identifier of one of a good or service.

17. The method of claim 10, wherein the data further comprises a recipient address.

18. (canceled)

19. A non-transitory computer-readable storage media storing instructions that are executable by one or more processors performing operations comprising:
presenting, via a user computing system, a graphical user interface (GUI) comprising a profile area and one or more interactive buttons;
in response to a selection of the one or more interactive buttons, receiving, from the user computing system, data comprising an anonymous request for transferring an amount of currency, wherein at least a portion of the data is signed with a group signature and a linking base, wherein the amount of currency is a math-based currency (MBC) and the group signature designates an amount of the MBC;
linking the at least the portion of the data signed with the group signature to a second at least a portion of data signed with the group signature of a previous request;
in response to validating the linking base, determining, by an account circuit, a group account membership of a sender of the request based on the group signature;
opening, la an opening circuit, an identity of the sender of the request;
determining a spending threshold or limit applies to the request based on a group account of the group account membership and the identity of the sender of the request;
applying one of the spending threshold or limit to the request for transferring an amount of currency;
transferring the amount of currency to a recipient based on application of the spending threshold or limit; and
submitting the transfer of the amount of currency request and a group public key of the group account to a MBC node of a blockchain storing the math-based currency.

20. The non-transitory computer-readable storage media of claim 19, the operations further comprising:
wherein linking is executed by a linking circuit; and
wherein the data further comprises a purchase request, an identifier of one of a good or service, and a recipient address.
